(19) United States
(12) Patent Application Publication
(10) Pub. No.: US 2016/0227800 A1
(43) Pub. Date: Aug. 11, 2016

(54) Method To Prevent Decomposition and Insect Infestation During Animal Dressing

(71) Applicant: Peter Balestracci, Las Vegas, NV (US)

(72) Inventor: Peter Balestracci, Las Vegas, NV (US)

(21) Appl. No.: 14/620,159

(22) Filed: Feb. 11, 2015

(51) Int. Cl. A23B 4/20; A01N 37/36; A22B 5/00; A01N 1/00

(52) U.S. Cl. CPC A23B 4/20; A01N 1/00; A01N 37/36; A22B 5/0082; A23V 2002/00

(57) ABSTRACT

A method to prevent decomposition and insect infestation during animal dressing includes the steps of killing of wild game and providing an anti-decomposition fluid. The anti-decomposition fluid comprises citric acid and water. The fluid is sprayed on the wild game as the wild game is being dressed to prevent growth on meat exposed during the dressing process.

### BACKGROUND OF THE DISCLOSURE

### Field of the Disclosure

The disclosure relates to anti decomposition and insect infestation compositions and more particularly pertains to a new such composition used in a method of protecting meat during the dressing of a wild animal in the field.

### SUMMARY OF THE DISCLOSURE

An embodiment of the disclosure meets the needs presented above by generally comprising the steps of killing of wild game and providing an anti-decomposition fluid. The anti-decomposition fluid comprises citric acid and water. The fluid is sprayed on the wild game as the wild game is being dressed to prevent growth on meat exposed during the dressing process.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### DESCRIPTION OF THE PREFERRED EMBODIMENT

As best indicated herein, the method to prevent decomposition and insect infestation during animal dressing generally comprises the killing of wild game. The wild game may comprise any wild game such as, for instance, dear, elk, bear or any other animal which is typically dressed in the field after being killed. While portions of meat are exposed, they are subject to rapid growth of bacteria and insect infestation as the dressing is accomplished outside in non-optimal temperature and sanitation conditions.

A fluid is provided which inhibits bacterial growth and the infestation of insects on the meat. The fluid comprises a composition of citric acid and water. More particularly, the composition may comprise by weight 20% citric acid and 80% water. The fluid is placed within a container, such as a spray bottle, to facilitate spraying of the fluid onto the meat.

In order to further allow for easy use of the method, the method may include the steps of providing the citric acid in crystalline form and within a packet that may be poured into the container, along with water, to make the composition. This will allow for greater portability and usefulness in the field as the user may utilize drinking water at the time needed for the fluid. It should be understood that that the amount of citric acid may vary and will be at least 10% weight of the composition and up to 50% weight.

In use, once an animal has been killed and before, or during the dressing thereof, the hunter will prepare the fluid, if needed. The fluid is then sprayed on the meat to prevent growth of bacterial on the meat. Furthermore, insects will avoid the fluid and thus there will be little chance of eggs being laid on the meat. The method will thus keep the meat from spoiling longer than without practicing the method.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A method of preventing bacterial and insect growth on wild game as the wild game is being dressed, said method comprising the steps of:
killing of wild game;
providing an anti-decomposition fluid, said anti-decomposition fluid comprising:
citric acid;
water; and
spraying the fluid on the wild game as the wild game is being dressed.

2. A method of preventing bacterial and insect growth on wild game as the wild game is being dressed, said method comprising the steps of:
killing of wild game;
providing an anti-decomposition fluid, said anti-decomposition fluid consisting of:
citric acid;
water; and
spraying the fluid on the wild game as the wild game is being dressed.

3. A method of preventing bacterial and insect growth on wild game as the wild game is being dressed, said method comprising the steps of:
killing of wild game;
providing an anti-decomposition fluid, said anti-decomposition fluid consisting of:
20% by weight citric acid;
80% by weight water; and
spraying the fluid on the wild game as the wild game is being dressed.
